(19) United States
(12) Patent Application Publication
(10) Pub. No.: US 2008/0016764 A1
(43) Pub. Date: Jan. 24, 2008

(54) PLANT CARE WIPES

(76) Inventor: JAMES H. WOLFE, LORENA, TX (US)

Correspondence Address: NAMAN, HOWELL, SMITH & LEE, P.O. BOX 1470, WACO, TX, 76703, US

(21) Appl. No.: 11/458,838

(22) Filed: Jul. 20, 2006

(51) Int. Cl. A01G 29/00

(52) U.S. Cl. 47/48.5

(57) ABSTRACT

The present invention is directed toward a system for quickly and efficiently cleaning and polishing live plant leaves. In particular, the present invention provides plant polish and cleaner in a disposable wipe form.

### BACKGROUND OF THE INVENTION

1. Field of the Invention

The present invention is directed toward an apparatus for quickly and efficiently cleaning and polishing live plant leaves. In particular, the present invention provides plant polish and cleaner in a disposable wipe form.

2. Background Information

The sale and care of live plants is a multibillion dollar industry in the United States. Live plants, more particularly, live indoor plants are coveted for the beauty and serenity they convey to a particular setting. Those settings range from public buildings, such as malls and hotels, to private residences. Furthermore, the nursery and florist industries, which supply the live plants also depend on the beauty a live plant adds to these environments to sustain and grow their respective business.

Over the years, a need has arisen in the maintenance and care of these live plants to treat the foliage such that they retain a fresh, shiny, and healthy look. This need is derived both on the supplier side and on the end user side. That is, the end user, of course, desires to keep their plant looking fresh and healthy for as long as possible. Regular maintenance, such as watering and fertilizing, is an excellent first step; however, as anyone in charge of maintenance of live plants knows, the foliage becomes dried and dulled by dust and over or under exposure to sunlight. Additionally, suppliers of live plants face the same problems of plant foliage becoming dusty or dirty prior to delivery. Hence, the need for a method of cleaning and/or polishing plant foliage is pressing throughout the industry.

In an effort to meet this need, a variety of products have developed throughout the years. Most prevalent are cleansing and polishing liquids or aerosols designed for spray-on or wipe-on application. These products work well for their intended purpose; however, they are extremely laborious to use with a significant number of steps required for proper use. First, with respect to the spray-on applications, the user must spray just the right amount of the formula onto the foliage in order to properly, but not overly saturate each leaf. If an inadequate amount of polish is applied to the leaf, the leaf will not be properly cleaned and shined; however, if the leaves are excessively sprayed, much of the valuable formula is wasted on areas of the plant in which it is not needed. Moreover, overspray also presents a problem to flooring, particularly to hard, polished flooring, as is typical in publicly accessed facilities, where a slip and fall hazard is created, potentially extending legal liability to the facility owners. Next, each leaf must be hand wiped in order to both complete the cleansing process and buff the foliage to a glossy shine. The leaves may be wiped with a soft, washable cloth or a soft disposable cloth, either of which presents its own additional problems. That is, if a washable cloth is used, not only must the maintenance provider have a large supply of such cloths because new cloths must be used as its successor gets too saturated and dirty to continue, but also, the cloths are particularly difficult to wash clean because of the oily polish mixture. On the other hand, if a disposable cloth is to be used, both dispenser and disposal costs are increased.

The wipe-on versions of these cleansing and polishing formulas, currently have many of the same drawbacks. First, the applicator (whether it be a sponge, or a cloth) must be saturated in the liquid. This may lead to a similar problem as presented with the overspray, if the formula is spilled or dripped during the saturation process. Next, the liquid must be applied to each individual leaf via the selected applicator. Finally, the labor is doubled by having to wipe the excess polish off of the plant and buff the leaves to a clean, fresh shine using a clean washable or disposable cloth. This not only increases the time and labor of the process, but it also leads to the same problems in cleaning or supplying and disposing of the applicators and drying cloths as those previously presented with the spray-on version.

In view of these limitations associated with the prior art, a substantial need exists for an apparatus which quickly and efficiently cleans and polishes plant foliage that also minimizes the hazards associated with the prior art. Applicant's invention, through a novel combination, provides such a solution.

### SUMMARY OF THE INVENTION

The general purpose of the present invention, which will be subsequently described in greater detail, is to provide a system for quickly and efficiently cleansing and polishing live-plant foliage without the labor, mess and hazard presented by the prior art.

In view of the foregoing, it is an object of the present invention to provide a system for polishing live-plant foliage that is easy to use.

It is another object of the present invention to provide a system for polishing live-plant foliage that decreases labor costs.

It is another object of the present invention to provide a system for polishing live-plant foliage that decreases the time required to complete the task.

It is another object of the present invention to provide a system for polishing live-plant foliage that reduces the risk of hazardous spills.

It is another object of the present invention to provide a system for polishing live-plant foliage that reduces the risk of hazardous overspray.

It is another object of the present invention to provide a system for polishing live-plant foliage that reduces the number of steps required to accomplish the task.

It is another object of the present invention to provide a system for polishing live-plant foliage that reduces amount of wasted polish.

In satisfaction of these and other related objectives, the present invention provides a system for efficiently polishing live-plant foliage. The present invention provides a system of packaged, disposable wipes impregnated with the optimal blend of cleansing and polishing ingredients. As will be discussed in the specification to follow, practice of the present invention allows for quickly and efficiently cleaning and polishing live-plant foliage using this system of disposable wipes.

The present invention is first comprised of a fibrous and disposable towel material impregnated with a plant cleansing and polishing formula via a spray application process as known in the art. The towel material is then cut into individual-sized members and packaged in a dispensing container designed to prevent the loss of moisture from the towels. From there, the end user has a simple, easy to apply solution for cleansing and polishing plant foliage of merely selecting a single wipe and applying the cleanser and polish to the leaf, leaving the leaf clean and dry, while restoring its glossy, healthy finish. In doing so, the present invention eliminates the need for containers of liquid; separate applicators, cleansing cloths, and drying cloths; and eliminating all of the hazards associated therewith.

In summary, then, an embodiment of the present invention provides a safe, efficient, and effective solution for the cleansing and polishing of live-plant foliage.

### DETAILED DESCRIPTION OF THE PREFERRED EMBODIMENT

In the preferred embodiment of the present invention, a dry, fibrous towel member is sprayed with a live-plant cleansing and polishing formulation. The towel member is preferably a cellulose material in either a woven or non-woven form. A non-woven sheet may contain a layer of wood pulp or blend of wood pulp and a layer of synthetic fiber such as polyester, rayon, nylon, polypropylene, polyethylene, or other cellulose polymers. Woven materials, such as cotton fibers, cotton/nylon blends, cotton/polyester blends, or other blends may be used as well.

The cleansing and polishing formulation is first comprised of equal portions of mineral oil and alcohol, each at between 4 and 8 percent by volume. The mineral oil used may be selected from a variety of mineral oils; however, preferably a light or white mineral oil is used. The alcohol product used is generally full strength isopropyl alcohol. Additionally, low levels of disinfectant, bactericide, and detergent are also present in the formulation, with the remaining mixture consisting of water. The detergent used in the preferred embodiment of the present invention is a nonionic surfactant, such as polyoxyethylene sorbitan monooleate or polyethylene glycol sorbitan monooleate, while the disinfectant used in the preferred embodiment is selected from a number of cationic surfactants, most preferably from the class of quaternary ammonium chlorides.

The formula impregnated towels are then cut to the appropriate size and packaged in containers in order to seal in the moisture from the wipes. The resulting product consists of prepackaged disposable wipes for use in cleansing and polishing plant foliage. The packaging may consist of individually packed wipes sealed in flexible, laminated packages or plastic tubs containing a number of stacked wipes as is commonly used for sanitary baby wipes.

In operation, the use of the present invention is simple and straightforward. First, one merely selects a wipe from the packaging. Then the wipe is rubbed onto individual plant foliage one leaf at a time, wherein at least some of the formulation is transferred. The result is cleaned, polished, and healthy looking foliage in one simple step, thereby reducing the additional labor and hazards associated with the prior art.

Although the invention has been described with reference to specific embodiments, this description is not meant to be construed in a limited sense. Various modifications of the disclosed embodiments, as well as alternative embodiments of the invention will become apparent to persons skilled in the art upon reference to the description of the invention. It is, therefore, contemplated that the appended claims will cover such modifications that fall within the scope of the invention.

I claim:

1. A system for cleansing and polishing plant foliage, comprising:
a disposable towel member, said towel member being fibrous; and
a liquid formulation comprised of a cleansing substance, a polishing substance, and
water, wherein said towel member is saturated with said liquid formulation.

2. The system of claim 1 wherein said polishing substance is comprised of mineral oil and alcohol.

3. The system of claim 2 wherein said polishing substance is comprised of equal portions of mineral oil and alcohol.

4. The system of claim 1 wherein said cleansing substance is comprised of a nonionic surfactant.

5. The system of claim 4 wherein said cleansing substance is further comprised of a cationic surfactant.

6. The system of claim 5 wherein said cleansing substance is further comprised of a bactericide.

7. The system of claim 1 further comprising a moisture resistant container encapsulating said towel member and said liquid formulation.

8. A system for cleansing and polishing plant foliage, comprising:
a disposable towel member, said towel member being fibrous;
a liquid formulation comprised of:
4-8% by volume of isopropyl alcohol;
4-8% by volume of mineral oil;
one or more of the members of the group consisting of nonionic surfactants, bactericides, and cationic surfactants; and
water, wherein said towel member is saturated with said liquid formulation;
and
a moisture resistant container encapsulating said disposable towel member and said liquid formulation.

9. The system of claim 8 wherein said cationic surfactant is a quaternary ammonium chloride.

10. The system of claim 8 wherein said nonionic surfactant is selected from the group consisting of polyoxyethylene sorbitan monooleate and polyethylene glycol sorbitan monooleate.

11. A method for cleansing and polishing plant foliage, comprising:
selecting a system for cleansing and polishing plant foliage comprising:
a disposable towel member, said towel member being fibrous;
a liquid formulation comprised of:
4-8% by volume of isopropyl alcohol;
4-8% by volume of mineral oil;
one or more of the members of the group consisting of nonionic surfactants, bactericides, and cationic surfactants; and
water, wherein said towel member is saturated with said liquid formulation; and
a moisture resistant container encapsulating said disposable towel member and said liquid formulation;
removing said disposable towel member; and
rubbing a live plant leaf, distributing at least a portion of said liquid formulation onto said plant leaf.
